(19) United States
(12) Patent Application Publication
(10) Pub. No.: US 2012/0288946 A1
(43) Pub. Date: Nov. 15, 2012

(54) NON-DESTRUCTIVE METHOD FOR DETECTING MACHINING BURNS OF A VERY-HIGH-STRENGTH STEEL, AND COLOUR CHART FOR CALIBRATING MACHINING BURNS OF SAID STEEL

(75) Inventors: Fabrice Aberne, Monein (FR); Laurent Huet, Gan (FR); Olivier Meneses, Ossun (FR)

(73) Assignee: MESSIER-BUGATTI-DOWTY, Velizy-Villacoublay (FR)

(21) Appl. No.: 13/574,689

(22) PCT Filed: Jan. 28, 2011
(86) PCT No.: PCT/FR2011/050180

§ 371 Date: Jul. 23, 2012

(30) Foreign Application Priority Data
Feb. 1, 2010 (FR) 1050670

(51) Int. Cl. G01N 21/75

(52) U.S. Cl. 436/78; 422/400

(57) ABSTRACT

A method for efficient, industrialisable detection of machining burns of VHS steel. Machined steel is immersed in an aqueous solution of acids including hydrofluoric acid and nitric acid. To define a burn degree, a color chart for calibrating machining burns of VHS steel detected using the method is prepared. The color chart can include studs of the examined steel subjected to deliberate damage by excessive resurfacing actions (or other machining modes), then submerged in the acid solution. The resurfacing actions can be simulated by overheated thermal treatment, between an ageing temperature (for example 510° C. for steel) and a solution annealing temperature (950° C. for the steel). The samples are classified according to the grey level thereof resulting from the immersion and corresponding to a predetermined hardness and thus to a predetermined level of damage.

### INTRODUCTION

The invention relates to a non-destructive method for detecting machining burns on stainless steel with very high corrosion resistance (VHS), resulting for example from the last grinding, in particular for the manufacturing of landing gears for aircrafts. Particularly aimed steels are Cr-, Ni-, Mb-, Al-, Ti-based alloys, for example steels known under the trade name AMS 5936, MLT 1302, Ma-0650-12 and Ma-0600-12.

The invention also relates to a colour chart for calibrating machining burns of VHS steels detected by the above method.

### TECHNICAL FIELD

The present invention relates to the field of the quality control of stainless steels after heat treatment and finish machining or grinding. Such a control turns out extremely useful because, upon the machining of work pieces, the material can reach excessive temperatures with regard to rated values and become then burned. But these machining burns generate a substantial variation of the mechanical properties of the material, even a likely cracking of the work pieces.

There are techniques of non-destructive testing for low-alloy VHS steels, e.g. the inspection by etching with acid composition, such as an alcoholic solution of nitric acid known under the naming NITAL.

But, this technique remains ineffective to highlight the machining burns on this type of stainless VHS steel in order to establish the state of the material after heat treatment.

### DISCLOSURE OF THE INVENTION

The invention aims at allowing the effective and industrialisable detection of the machining burns of stainless steels of VHS type. To do it, a particular bath of a hydrofluoric acid-based acid solution provides a visual indication scaled depending on burn state of the steels immersed in the bath.

More exactly, the object of the present invention relates to a non-destructive method for detecting machining burns on VHS stainless steels, wherein the machined steel is immersed in an aqueous solution of acids comprising hydrofluoric acid and nitric acid, and wherein a colour chart for calibrating machining burns of steels is prepared by immersing samples subjected to voluntary damages in said aqueous solution of acids. The samples are classified by their grey level resulting from immersion and corresponding to a definite hardness. The steel is then compared with the colour chart of calibrated colouring.

According to particular embodiments:
the duration of immersing in the solution of acids is at least 5 minutes;
the amounts of hydrofluoric acid and nitric acid in the solution are substantially the same;
the amount of all the acids is lower than the amount of water in the solution;
the solution consists, in volume, from 10 to 20%, preferably 15% of hydrofluoric acid, from 10 to 20%, preferably 15% of nitric acid, and from 60% to 80%, preferably 70% of water;
the solution is free of hexavalent chromium (Cr6) which is removed by any known means, in particular by anion exchange in columns of grafted celluloses or by addition of a solution of ferric sulfate; the Cr6 chromium is extremely toxic and its non-proliferation is very important for human and to protect environment;
the steel is then immersed in a bath of nitric acid for removing the soot produced by the first etching, the soot being formed by residues which risk to degrade the reading of the machining burns;

The acid solution of the method according to the invention allows an indication of elementary burn of VHS steel corresponding to at least 3% decreasing of the hardness of the tested steel to be obtained, upon an immersing of this steel during about 5 min.

The colour chart comprises samples subjected to voluntary damages, for example by variable excessive grindings. The samples are comprised by specimen regions subjected to variable grindings of VHS steel to be tested or by blocks of this steel subjected to heat treatments with variable overheating. The same grey level corresponds to the same level of undergone damage whatever is the grinding type, real or feigned.

According to particular embodiments:
the samples undergo a preliminary pickling by sand blasting to homogenize their surface roughness in order to obtain a better contrast of the colouring after immersing in the bath of acids;
the formed soot is removed by immersing in a bath of nitric acid before final rinsing in water.

The invention also relates to a colour chart for calibrating machining burns of VHS steels detected by the above method.

Other advantages and characteristics of the present invention will become evident from the reading of the ensuing description and which relates to an example of implementation, with reference to the drawings that represent, respectively:

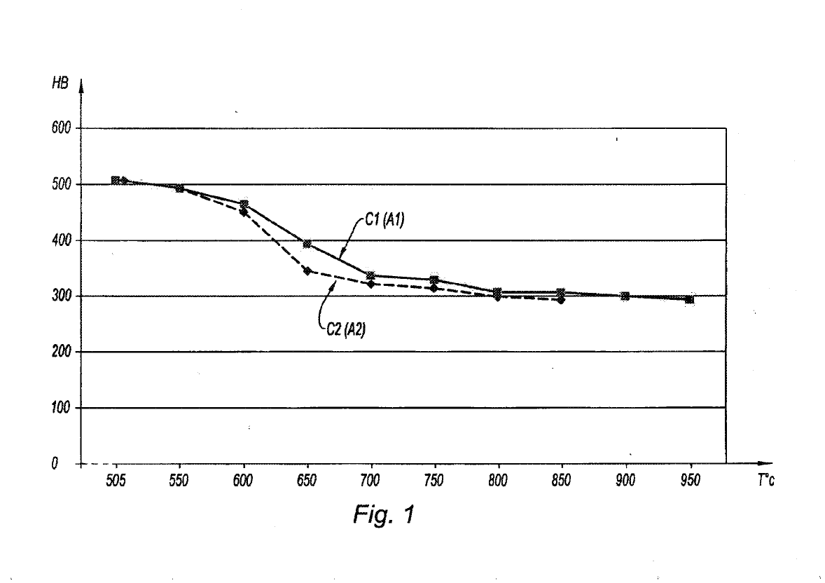

FIG. 1: a graph of hardness values for samples of two VHS stainless steels brought up to various overheating temperatures;

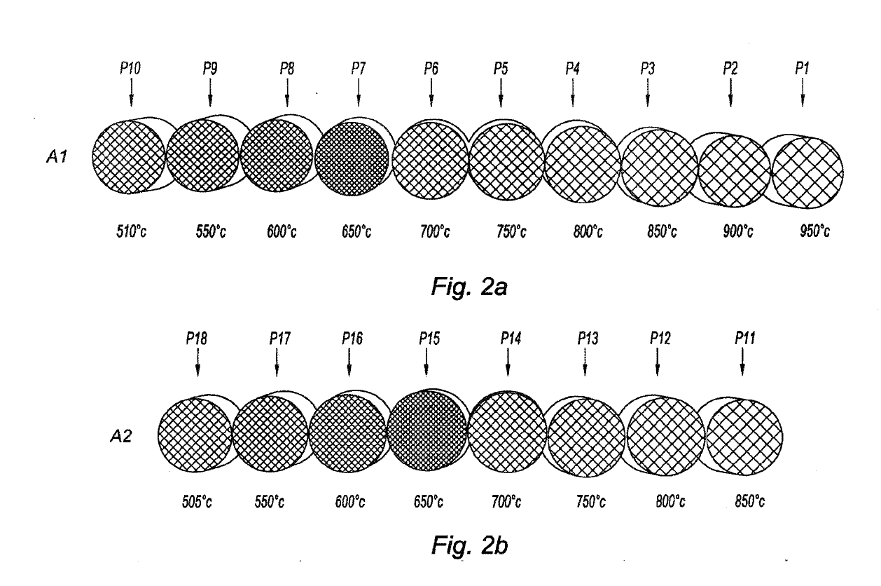

FIGS. 2a and 2b: top views of blocks of two VHS stainless steels having undergone overheating temperatures, corresponding to differentiated feigned grindings, by means of various ageing temperatures from standard ageing temperature until the solutionizing temperature;

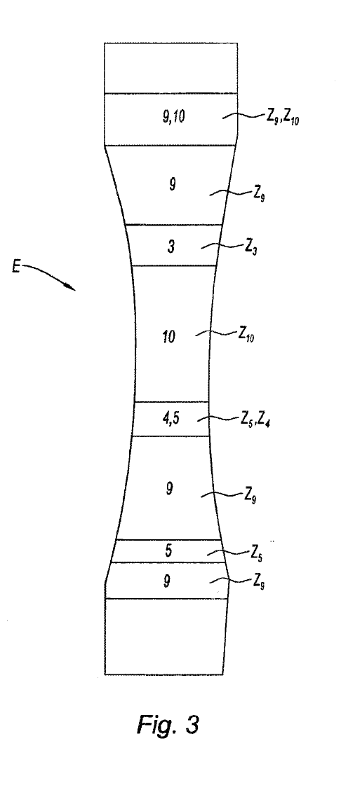

FIG. 3: a top view of a specimen of a VHS steel cut in regions having undergone voluntary grindings leading to differentiated damages, and

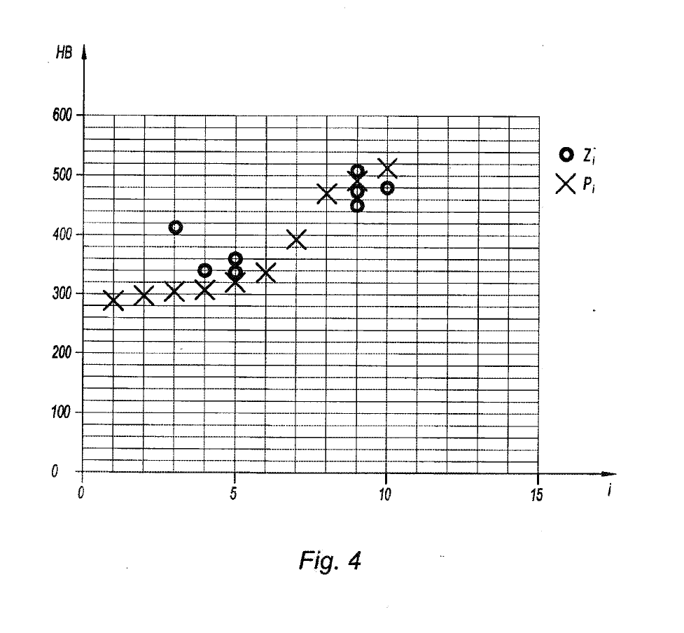

FIG. 4: a correlation graph between the blocks and regions of a VHS steel, having undergone equivalent, feigned or real, grindings, depending on the hardness.

In order to prepare a colour chart for calibrating machining burns for two alloyed VHS stainless steels, AMS 5936 (Custom 465) and MLT 1302 (MLX17), hereinafter mentioned as A1 and A2, blocks of samples from each of these steels—P1 to P10 and P11 to P18, respectively—were prepared. The blocks were machined from alloyed A1 and A2. These blocks are cylindrically shaped, with a diameter equal to 15 mm and height equal to 9 mm in the realized example.

The heat conditions of a treatment for the blocks of A1 and A2 alloys involving damages equivalent to grindings responsible for burns were determined. In both cases, grindings feigned by heat treatment or real, the same grey levels formed by immersion in a definite bath of acids correspond therefore to an equivalent state of hardness. The grey levels can so serve for defining a given state of damage.

At first, the blocks undergo a heat treatment by overheating with various temperatures, in order to create defects feigning damages or burns resulting from excessive grindings. At this end, the blocks are successively introduced into a laboratory furnace at various overheating temperatures. The temperatures, measured by a thermocouple, vary with a 50° increment and are spread out between the ageing temperature (Tv) and the solutionizing temperature (Tr) for each alloy: for A1, Tv=510° C. and Ts=950° C.; for A2, Ts=505° C. and Tr=850° C.

The Brinell hardness (HB) for the various blocks is then measured by a classic method in order to characterize each block by a known quantitative parameter. The obtained results were put back on the graph illustrated in FIG. 1. It seems that each curve of hardness C1 and C2 for the blocks from alloys A1 and A2 decreases substantially from a temperature just above the ageing temperatures to stabilize—while continuing to decrease weakly—until temperatures substantially above solutionizing temperatures.

The method according to the invention then consists in plunging the blocks into a bath containing two strong inorganic acids: hydrofluoric acid and nitric acid, in equal amounts in the preferred example. In this example, for 100 ml, the solution contains 15 ml of each acid and 70 ml of water.

In order to improve their surface roughness and the contrast of the subsequent colouring, the blocks are advantageously pickled by high pressure sand blast.

Here, the immersion lasts 5 minutes. To remove the “soot”, consisted of residues, which forms after immersing, these blocks are then plunged into another bath of nitric acid for a few minutes. A final rinsing with water is performed.

FIGS. 2a and 2b respectively present a top face of the blocks P1 to P10 from the A1 alloy and of the blocks P11 to P18 from the A2 alloy after immersing. Depending on the undergone treatment, which involves increasing damages with the temperature, the blocks present differentiated hues according to a contrasted gradation of grey level. In order to highlight the hue differences, the top faces present screens the feature density of which reflects the various grey levels. The drawing reminds the corresponding treatment temperatures of the blocks, from 510 to 950 and 505 to 850° C., respectively.

Referring to FIG. 3, a top view of a steel specimen A1 is cut in regions Z1 having undergone voluntary grindings of increasing intensity, leading to equally increasing damages. Measures of HB hardness are performed for each zone Z1 and the obtained values were put back on the drawing.

The specimen is then plunged into a bath of acids having the same composition as previously used for the blocks with feigned grinding. The further treatments of pickling before immersing and of cleaning after immersing are also realized. The regions Zi and the blocks Pi having the same grey level have the same index “i”.

On the graph of the FIG. 4, the blocks Pi and the regions Zi are classified in abscissa depending to their grey level “i”, and the HB hardness of these regions and blocks is put back in ordinate. The correlation of the hardness values for regions and blocks having the same number “i”, i.e. having undergone equivalents mechanical (real grindings) and heat (feigned grindings) treatments, is confirmed by this graph. A decrease about 3% of HB hardness is noticed between two successive values of “i”. The grey level “i” is thus one degree of precise damage.

The invention is not limited to the described or represented examples. It is for example possible to add another acid in the solution, for example hydrochloric acid, in particular in an amount equivalent to that of the other acids.

Besides, the immersing duration in the bath of hydrofluoric/nitric acids can be prolonged beyond 5 minutes according to the steels and degrees of burns, however without overtaking 60 minutes or equivalent for reasons of efficiency.

It is also possible to provide for other feigned grindings: by electron bombardment, laser beam or by ultra-sounds, or furthermore by targeted etching.

The machining modes others than the grinding can be used such as, for example, turning or milling.

1-7. (canceled)

8. A non-destructive method for detecting machining burns for VHS stainless steels, comprising:
immersing the machined steel in an aqueous solution of acids including hydrofluoric acid and nitric acid;
preparing a color chart for calibrating machining burns of steels by immersing samples subjected to voluntary damages in the aqueous solution of acids;
classifying the samples by their grey level resulting from the immersing and corresponding to a definite hardness; and
then comparing the steel with the color chart of calibrated coloring.

9. A non-destructive method of detection according to claim 8, wherein a duration of immersion in the solution of acids is at least 5 minutes.

10. A non-destructive method of detection according to claim 8, wherein amounts of hydrofluoric acid and nitric acid in the solution are substantially the same.

11. A non-destructive method of detection according to claim 10, in which the solution consists, in volume, from 10 to 20% of hydrofluoric acid, from 10 to 20% of nitric acid, and from 60 to 80% of water.

12. A non-destructive method of detection according to the claim 8, wherein the steel is then immersed in a bath of nitric acid for removing soot.

13. A method of detection according to the claim 8, wherein blocks of the steel are machined and subjected to heat treatments in variable overheating corresponding to feigned grindings.

14. A color chart for implementation of the method of detection according to claim 8.
